(19) United States
(12) Patent Application Publication
(10) Pub. No.: US 2006/0213010 A1
(43) Pub. Date: Sep. 28, 2006

(54) Mattress sled

(76) Inventor: David T. Davis, Bethlehem, PA (US)

Correspondence Address: DUANE MORRIS LLP;IP DEPARTMENT, 30 SOUTH 17TH STREET, PHILADELPHIA, PA, 19103-4196, US

(21) Appl. No.: 11/386,333

(22) Filed: Mar. 22, 2006

Related U.S. Application Data
(60) Provisional application No. 60/664,313, filed on Mar. 22, 2005.

(51) Int. Cl. A61G 7/14; A61G 1/00

(52) U.S. Cl. 5/626; 5/81.1 R

(57) ABSTRACT

A system for transporting an nonambulatory patient including a mattress having longitudinal sides and a bottom surface and a panel having longitudinal side edges, a head end edge, and a bottom surface coated with a low coefficient of friction coating. The panel is positioned below the bottom surface of the mattress, and includes a plurality of side straps extending outwardly from the longitudinal side edges in spaced relation to one another. A handle is located along at least one edge of the panel. The side straps are wrapped around the mattress so as to cause the mattress to curl so that the longitudinal sides are moved upwardly to thereby form a central longitudinal pocket suitable for cradling a patient positioned upon the mattress. The head end handle is then pulled to drag the curled mattress and the panel along a surface upon the low coefficient of friction coating.

This application claims priority from co-pending Provisional Patent Application Ser. No. 60/664,313, filed Mar. 22, 2005, and entitled Safety Sled.

### FIELD OF THE INVENTION

The present invention relates to patient evacuation devices for non-ambulatory or bed-ridden persons, and particularly to a device in which a patient may be rapidly and securely transferred while lying on a mattress.

### BACKGROUND OF THE INVENTION

Many prior art methods and systems are known for shifting or moving a patient who is unable to move themselves. For example, in U.S. Pat. No. 4,793,008, a patient transfer mat is disclosed for aiding the moving of a patient who cannot move himself. The mat includes an elongated body portion with a substantially rectangular shape adapted to be placed transversely under the patient. The body portion is rigid yet flexible enough to at least partially conform to the contour of a portion of the patient's body. The mat includes grasping openings in each end with slots for securing a strap to secure the patient to the mat. A pair of mats are placed under the patient forming a transfer method and system to move the patient by sliding or lifting.

In U.S. Pat. No. 4,736,474, a rescue transportation device is provided having an inflatable support member with a horizontally extending main section and an inclined section adjacent to one end of the main section extending upwardly and outwardly. A cover is adapted to extend about the inflatable support member and is capable of placement on and off the inflatable support member by way of a slot defined to facilitate fitting. A wide open mesh head restraint device is attachable with respect to the cover to receive a user's head and hold it to the main support member. A lower body restraint device is also attachable to the cover and is adapted to receive and hold the user's lower body. Two restraint attachment devices are secured to the cover and are adapted to receive the head restraint or the lower body adjacent to the inclined section. In another orientation, the head of the user will be at the opposite end of the inflated support member from the inclined section. Towing securement features are defined on the cover adjacent the inclined section or adjacent the opposite section.

In U.S. Pat. No. 5,249,321, an evacuation or rescue device for a bed-ridden or non-ambulatory person is provided for quickly securing the person to a movable underlying mattress. The device comprises two sheets deployable one from the head-end and one from the foot-end. When deployed the head-end sheet meets the foot-end sheet over the persons chest or abdomen. The head-end sheet has an opening for the head. The two sheets, which are interconnected underneath the mattress, are then tightened downwardly over the long sides of the mattress by means of looped ropes pulled one from the head-end side and the other from the foot-end side. The ropes are self cleating when tightened and quickly secure the person in readiness for rescue and evacuation by a single individual if necessary.

In U.S. Pat. No. 5,539,945, a system for transporting a person on a stretcher between upper and lower platforms connected by a stairway is provided that includes a retractable cable source located at the upper level with one end of the stretcher attached to the cable. In this way, an assistant may grasp the other end of the stretcher and transport the individual up or down the stairway with the cable providing tension to stabilize movement. The device appears to be suited to buildings having multiple levels and a larger number of nonambulatory individuals, as might be found in hospitals and convalescent centers. The system also includes one or more stretchers and cable supply devices accessible at multiple stairwell levels. Multiple stretchers are located at either or both levels, so that the retractable cable source provides sufficient tension to assist in pulling the stretcher up the stairway. The retractable cable source includes a housing into which the cable retracts and a loaded spring disposed within the housing. The stretcher is flexible to permit turning of the stretcher during transport.

None of the foregoing devices and systems are completely satisfactory for moving nonambulatory patients quickly and safely while remaining on their mattress.

### SUMMARY OF THE INVENTION

The present invention provides a system for transporting a nonambulatory patient. The patient is positioned upon a mattress having longitudinal sides and a bottom surface. A sled panel is located below the bottom surface of the mattress. The sled panel has longitudinal side edges, a head end edge, and a bottom surface that is covered with a low coefficient of friction coating. The sled panel also includes a plurality of side straps extending outwardly from each of its longitudinal side edges in spaced relation to one another. A handle is located at one or both ends of the sled panel. In an emergency, the side straps are wrapped around the mattress so as to cause the mattress to curl up upon itself so that the longitudinal sides are moved upwardly. This upward curling of the mattress' longitudinal side edges forms a central longitudinally oriented pocket that cradles or cocoons the patient. If the non-ambulatory patient needs to be moved in a hurry, e.g., during a fire emergency, an attendant may simply tighten the edge straps about the patient and mattress so as to curl the mattress around the patient. This action also tends to narrow the mattress. A handle is then grabbed so as to drag the curled mattress and cocooned patient from the bed upon the panel. The entire assembly is then dragged along a floor surface aided by the low coefficient of friction coating on the bottom surface of the sled panel.

### BRIEF DESCRIPTION OF THE DRAWINGS

These and other features and advantages of the present invention will be more fully disclosed in, or rendered obvious by, the following detailed description of the preferred embodiments of the invention, which are to be considered together with the accompanying drawings wherein like numbers refer to like parts and further wherein:

FIG. 1 is an end-on perspective view of a sled panel used in connection with a system for transporting nonambulatory patients formed in accordance with the present invention, and showing a portion of a low coefficient of friction bottom surface;

FIG. 2 is another end-on perspective view of the sled panel shown in FIG. 1;

FIG. 3 is a perspective view of a sled panel positioned upon a bed frame in accordance with one aspect of the present invention;

FIG. 4 is a perspective view of a mattress positioned over top of a sled panel on a bed frame in accordance with the present invention;

FIGS. 5-6 are perspective views of a mattress positioned over top of a sled panel on a bed frame and with a patient strapped into the system of the invention ready to be evacuated;

FIG. 7 is an end on perspective view of the system for transporting nonambulatory patients formed in accordance with the present invention, illustrating the cocooning effect created by the present invention; and

FIGS. 8-9 are perspective views of the system for transporting nonambulatory patients formed in accordance with the present invention showing the removal of the system from a bed frame and ready for evacuation.

### DETAILED DESCRIPTION OF THE PREFERRED EMBODIMENT

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling, or connection that allows the pertinent structures to operate as intended by virtue of that relationship. In the claims, means-plus-function clauses, if used, are intended to cover the structures described, suggested, or rendered obvious by the written description or drawings for performing the recited function, including not only structural equivalents but also equivalent structures.

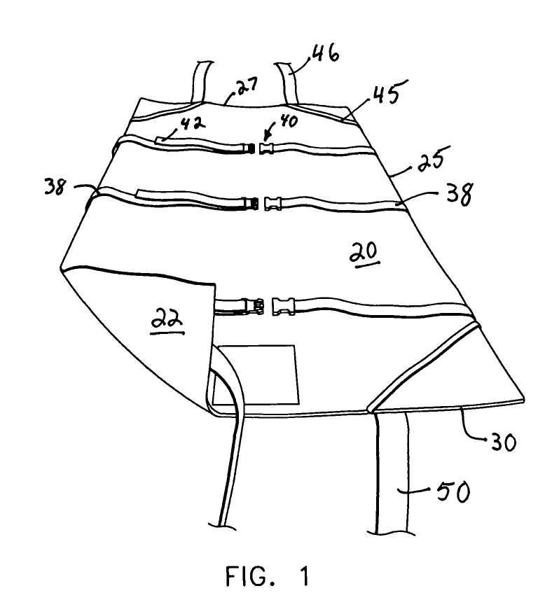

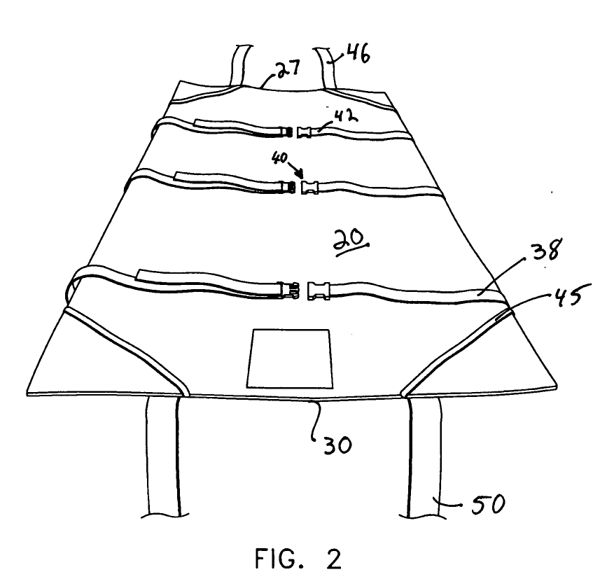

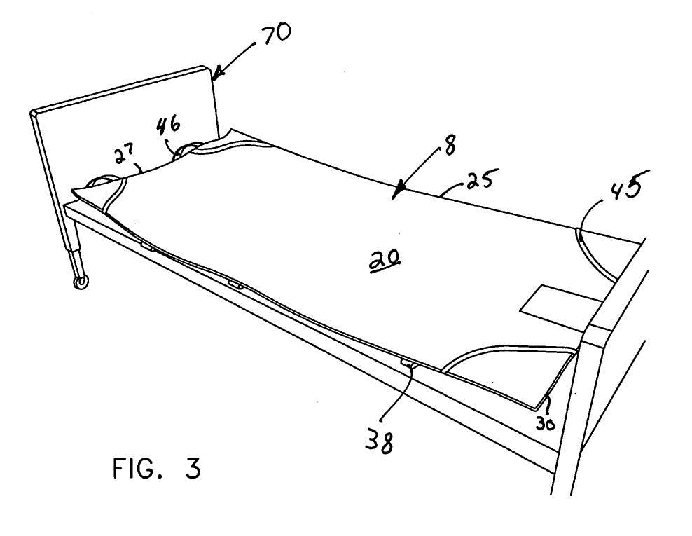

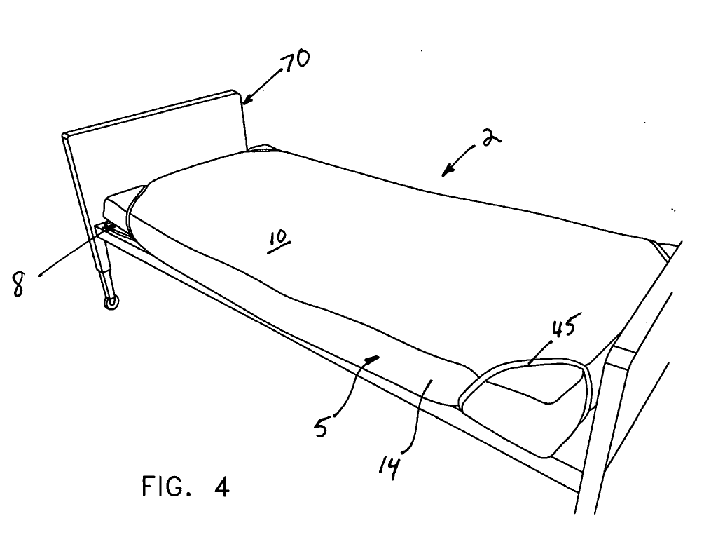

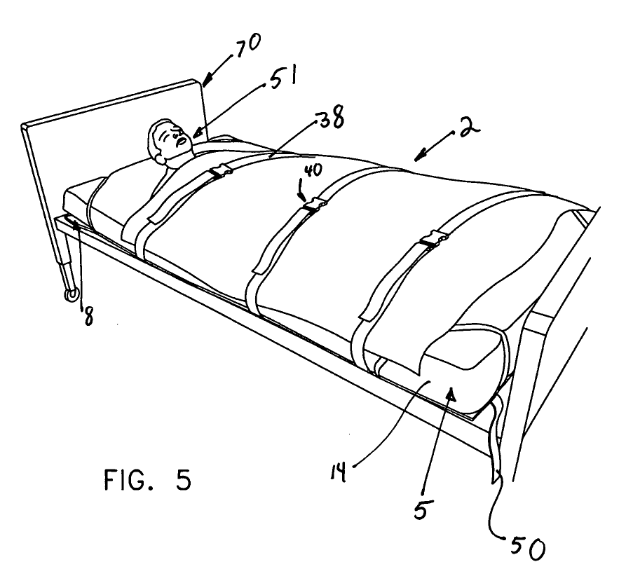

Referring to FIGS. 1-5, the system for transporting an nonambulatory patient 2 of the present invention includes a mattress 5 and sled panel 8. Mattress 5 includes a top surface 10, a bottom surface 12, and a perimeter wall 14 (FIGS. 4-6). Mattress 5 may comprise a simple pad, a spring and padding internal construction, an air-filled mattress, or a solid foam core, as are known in the art, as long as mattress 5 is sufficiently resilient so as to be capable of flexing or curling about its longitudinal axis.

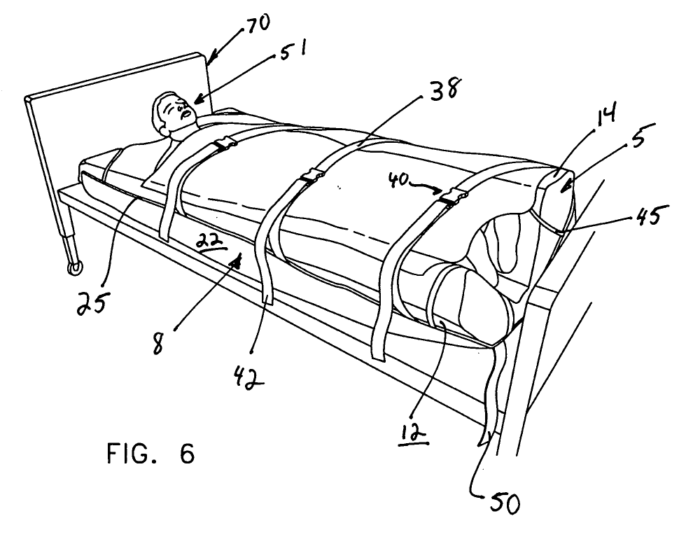

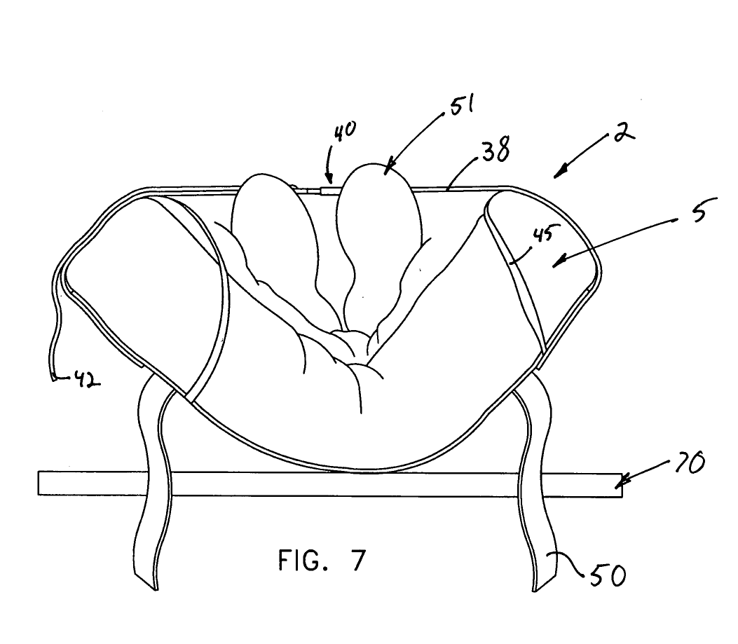

Sled panel 8 has a top surface 20, a bottom surface 22, longitudinally extending side edges 25, a transverse head edge 27, and a transverse foot edge 30 (FIGS. 1-3). Sled panel 8 is often formed of one or more layers of 400D nylon pack cloth with a Teflon® coated polyester forming the bottom most layer of the panel. The Teflon® coating covers the outer side of bottom surface 22 so as to provide a low coefficient of friction surface that is suitable for dragging sled panel 8 on a typical hospital or long term care floor. A plurality of straps 38 extend outwardly from each of longitudinal side edge 25 in spaced relation to one another so that at least three pairs of straps 38 are arranged along the length of sled panel 8. Fasteners 40 are located on the free ends 42 of each of straps 38, e.g., buckles, a Velcro® hook-and-loop system, etc. A resilient or elastic garter 45 is located across each corner of sled panel 8, typically at a forty-five degree angle, and a handle strap 46 is located at a transverse head edge 27 of sled panel 8 and a second handle strap 50 is located at transverse foot edge 30. In one preferred embodiment, sled panel 8 includes at least three straps 38 that are spaced from one another along each longitudinal side edge 25, and that are long enough to extend over both mattress 5 and patient 51 lying on top of the mattress. When each of straps 38 are tightened, mattress 5 cocoons patient 51 and tends to narrow resulting in less surface area of bottom surface 22 contacting the floor providing for an easier dragging (FIGS. 6 and 7). The narrowing of mattress 5, as a result of the tightening of straps 38, allows system 2 to be moved more easily through doorways in a home as well as a hospital or long term care facility.

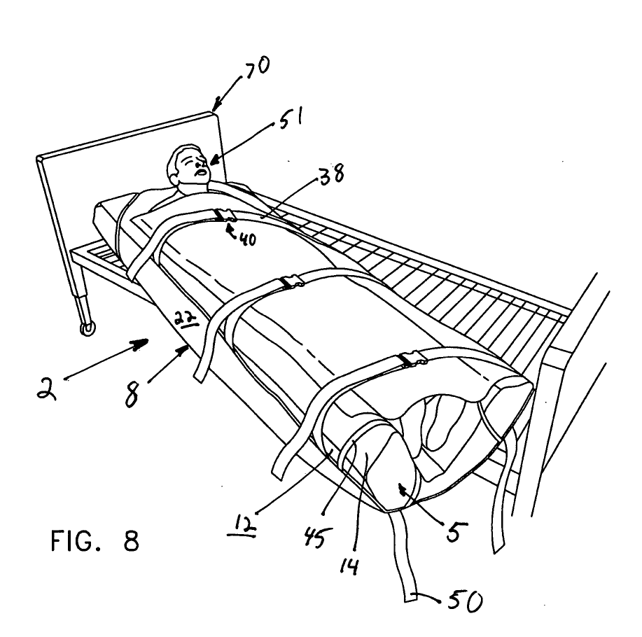

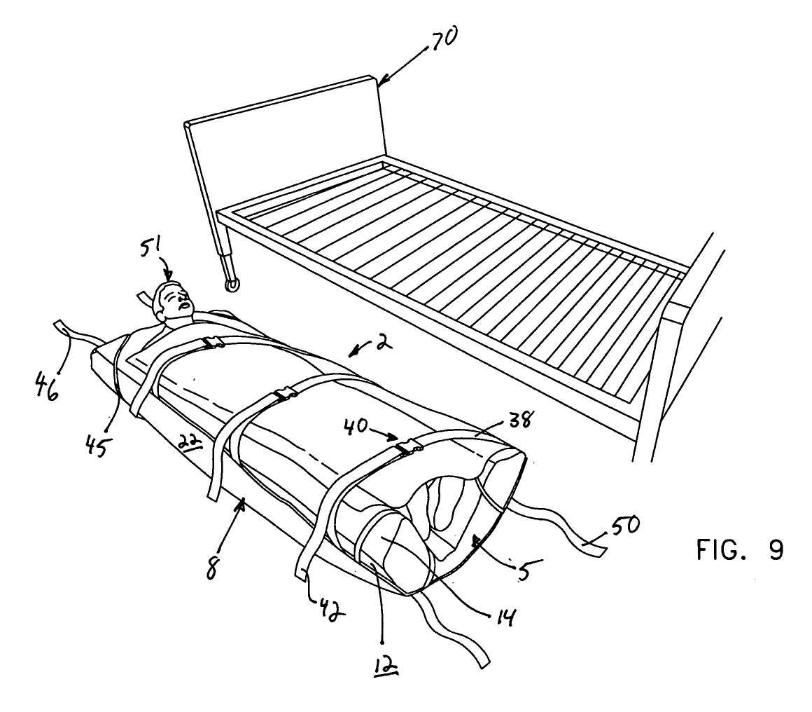

Referring to FIGS. 4-9, a system 2 for transporting a non-ambulatory patient in accordance with the present invention is formed in the following manner. Mattress 5 is first lifted off of its bed frame 70, e.g., lifted above a box spring, so that sled panel 8 may be positioned below bottom surface 12 of mattress 5. In this position, plurality of straps 38 extend outwardly away from the perimeter wall 14 of mattress 5. Once in this position, mattress 5 is lowered on top of sled panel 8. Resilient garters 45 are each lifted and stretched above each of the four corners of mattress 5 and released so as to spring back, engage, and grip mattress 5 across its four corners. In this way, sled panel 8 is retained on bottom surface 12 of mattress 5. Also in this position, plurality of straps 38 are either rolled or tucked under mattress 5 such that fasteners 40 on free ends 42 are out of sight, but accessible for quick deployment. In one embodiment of the invention, mattress 5 includes longitudinal perimeter walls 14 that also have pockets for storing straps 38 when not in use.

Referring to FIGS. 6-9, if an emergency arises, requiring immediate evacuation of a non-ambulatory patient residing on mattress 5, each of straps 38 is extended outwardly away from perimeter wall 14 and wrapped over the top of mattress 5 and patient 51. Once in this position, each of straps 38 are fasteningly engaged with one another, via fasteners 42, so as to be pulled taut over patient 51 and mattress 5. As this occurs, both longitudinal sides of mattress 5 comprising perimeter walls 14 begin to curl upwardly so as to form a pocket or cocoon around patient 51. In this position, perimeter wall 14 moves upwardly and inwardly so that mattress 5 forms a substantially “U-shaped” configuration. Once straps 38 are fastened to one another, so that mattress 5 is in an upwardly curled position, handle strap 46 or 50 can be grabbed by an attendant so as to drag both sled panel 8 and curled mattress 5 off of bed frame 70 and out of harm's way.

It is to be understood that the present invention is by no means limited only to the particular constructions herein disclosed and shown in the drawings, but also comprises any modifications or equivalents within the scope of the claims.

What is claimed is:

1. A system for transporting an nonambulatory patient comprising, in combination:
a mattress having longitudinal sides and a bottom surface; and
a panel having longitudinal side edges, a transverse edge, and a bottom surface coated with a low coefficient of friction coating, said panel being positioned below said bottom surface of said mattress, wherein said panel includes a plurality of side straps extending outwardly from said longitudinal side edges in spaced relation to one another and at least one handle along a transverse edge such that said side straps are wrapped around said mattress so as to cause said mattress to curl so that said longitudinal sides are moved upwardly to thereby form a central longitudinal pocket suitable for cradling a patient positioned upon said mattress, wherein said head end handle is pulled to drag said curled mattress and said panel along a surface upon said low coefficient of friction coating.

2. A system according to claim 1 wherein said panel is formed of one or more layers of 400D nylon pack cloth with a Teflon® coated polyester forming a bottom most layer of said panel.

3. A system according to claim 2 wherein said Teflon® coated polyester covers an outer side of a bottom surface so as to provide a low coefficient of friction surface that is suitable for dragging said panel on a floor.

4. A system according to claim 1 wherein said plurality of straps extend outwardly from each longitudinal side edge of said mattress in spaced relation to one another so that at least three pairs of straps are arranged along the length of said panel.

5. A system according to claim 1 wherein each of said plurality of straps includes a fasteners located on a free end.

6. A system according to claim 1 wherein said panel includes garters located across each corner at a substantially forty-five degree angle.

7. A system according to claim 1 wherein said handle is located at a first transverse edge of said panel and a second handle is located at a second transverse edge.

8. A system according to claim 1 wherein said panel includes at least three straps that are spaced from one another along each longitudinal side edge, and that are long enough to extend over both said mattress and a patient lying on top of said mattress.

9. A system according to claim 1 wherein said when each of said straps is engaged with a corresponding strap, and tightened, said mattress narrows resulting in less surface area of bottom surface contacting a floor providing for an easier dragging.

10. A system for transporting an nonambulatory patient comprising, in combination:
a pad having longitudinal sides and a bottom surface; and
a panel having longitudinal side edges, a transverse end edge, and a bottom surface including means for fastening said panel to said bottom surface of said pad, said panel being positioned below said bottom surface of said mattress, wherein said panel includes a plurality of side straps extending outwardly from said longitudinal side edges in spaced relation to one another and at least a transverse end handle such that said side straps are wrapped around said pad so as to cause said pad to curl so that said longitudinal sides are moved upwardly to thereby form a central longitudinal pocket suitable for cradling a patient positioned upon said pad, wherein said head end handle is pulled to drag said curled pad and said panel along a surface upon said low coefficient of friction coating.

11. A system according to claim 10 wherein said panel is formed of one or more layers of 400D nylon pack cloth with a Teflon® coated polyester forming a bottom most layer of said panel.

12. A system according to claim 11 wherein said Teflon® coated polyester covers an outer side of a bottom surface so as to provide a low coefficient of friction surface that is suitable for dragging said panel on a floor.

13. A system according to claim 10 wherein said plurality of straps extend outwardly from each longitudinal side edge of said pad in spaced relation to one another so that at least three pairs of straps are arranged along the length of said panel.

14. A system according to claim 10 wherein each of said plurality of straps includes a fasteners located on a free end.

15. A system according to claim 10 wherein said panel includes garters located across each corner at a forty-five degree angle.

16. A system according to claim 10 wherein said handle is located at a first transverse edge of said panel and a second handle is located at a second transverse edge.

17. A system according to claim 10 wherein said panel includes at least three straps that are spaced from one another along each longitudinal side edge, and that are long enough to extend over both said pad and a patient lying on top of said pad.

18. A system according to claim 10 wherein said when each of said straps is engaged with a corresponding strap, and tightened, said pad narrows resulting in less surface area of bottom surface contacting a floor providing for an easier dragging.

19. A system for transporting an nonambulatory patient comprising, in combination:
a pad having longitudinal sides and a bottom surface; and
a panel having two longitudinal side edges, two transverse edges, and a bottom surface including means for fastening said panel to said bottom surface of said pad, said panel being positioned below said bottom surface of said pad, wherein said panel includes three side straps extending outwardly from each longitudinal side edge in spaced relation to one another and two handles one located at each transverse edge such that said side straps are wrapped around said pad so as to cause said pad to curl so that said longitudinal sides are moved upwardly to thereby form a central longitudinal pocket suitable for cradling a patient positioned upon said pad, wherein one of said handles is pulled to drag said curled pad and said panel along a surface upon said low coefficient of friction coating.
